(19) United States
(12) Patent Application Publication
(10) Pub. No.: US 2023/0340821 A1
(43) Pub. Date: Oct. 26, 2023

(54) AUTOMATIC DOOR CLOSER

(71) Applicant: The Cooler Closer LLC, Wheeling, IL (US)

(72) Inventors: Hazem Tabahi, Wheeling, IL (US); Tony Rasho, Braceville, IL (US)

(21) Appl. No.: 17/789,779

(22) PCT Filed: Dec. 7, 2020
(86) PCT No.: PCT/US20/63633

§ 371 Date: Jun. 28, 2022

Related U.S. Application Data
(60) Provisional application No. 62/944,447, filed on Dec. 6, 2019.

(51) Int. Cl. E05F 1/10

(52) U.S. Cl. CPC E05F 1/105; E05Y 2201/624; E05Y 2201/692; E05Y 2201/716; E05Y 2201/722; E05Y 2900/102; E05Y 2900/132

(57) ABSTRACT

The present disclosure provides reliable automatic door closers suitable for use in a variety of high-frequency use settings, such as commercial walk-in cooler and/or freezer doors.

### PRIORITY CLAIMS

This application is a national stage entry of PCT/US20/63633, filed Dec. 7, 2020, which claims priority to U.S. Provisional Patent Application Ser. No. 62/944,447, filed Dec. 6, 2019, the entire contents of each of which are incorporated herein by reference and relied on.

### TECHNICAL FIELD

The present disclosure provides reliable automatic door closers suitable for use in a variety of high-frequency use settings, such as commercial walk-in cooler and/or freezer doors.

### BACKGROUND

Commercial-grade door closing devices typically include a spring and/or hydraulic base unit mounted to a door, and a hinged arm connecting the base unit to a stationary object, such as the door jamb or the wall. However, such devices (including, for example, the industry-standard Kason-branded door closer devices) suffer from unreliability, especially when used on doors that are heavy and/or frequently used, such as the door to a commercial walk-in cooler and/or freezer. Failure frequently occurs with such devices and, when used on doors to temperature-controlled rooms, can cause catastrophic loss or further damage to the physical plant, can waste electricity (e.g., for inefficient cooling), and/or unnecessary wear on the cooling compressor when the door fails to fully close.

There remains a need for reliable automatic door closing devices.

### SUMMARY

The present disclosure provides reliable automatic door closers suitable for use in a variety of high-frequency use settings, such as commercial walk-in cooler and/or freezer doors.

In one embodiment, the present disclosure provides a door closer (10) comprising: an energy storage component (200) including a rotatable spindle (260); and an inflexible arm component (100) in mechanical association with the rotatable spindle and comprising: an arm (110) having a first end section (110a) associated with the rotatable spindle, a second end section (110c) disposed substantially opposite the first end section, a middle section (110b) disposed between the first end section and the section end section, and a roller (120) at the second end section substantially opposite the first end section.

In other embodiments, the present disclosure provides an inflexible arm component (100) for use with an automatic door closer base unit (200), the arm component comprising: a first end section (110a) configured to mate with a rotatable spindle (260) of the automatic door closer base unit; a second end section (110c) disposed substantially opposite the first end section and associated with a roller (120); and a middle section (110b) disposed between the first end section and the section end section.

In still other embodiments, the present disclosure provides an automatic door closer (10) comprising: a housing (210) including: a longitudinal bore (220); a spring (250) disposed in the longitudinal bore; a piston (230) disposed in the longitudinal bore and adjacent the spring, the piston including: an orifice (235) in restricted fluid communication with the longitudinal bore, and a toothed rack (238) disposed within the orifice; hydraulic fluid (225) the longitudinal bore; a toothed pinion (262) in rotational communication with the toothed rack and including a post (260) external to the housing; and an arm (100) in non-rotational mechanical communication with the post, the arm consisting essentially of: a non-hinged shaft (110) extending longitudinally from the post and including a proximate end (110a) in mechanical communication with the post and a distal end (110c) opposite the proximate end, and a roller (120) disposed at the proximate end of the non-hinged shaft and in rotational communication with the non-hinged shaft.

### BRIEF DESCRIPTION OF THE FIGURES

FIG. 1 shows a plan view of an automatic door closer consistent with one embodiment of the present disclosure.

FIG. 2 shows a partial cross-sectional view of the automatic door closer of FIG. 1.

FIG. 3 shows a perspective view of an arm of an automatic door closer consistent with one embodiment of the present disclosure.

FIG. 4A shows a perspective view of an automatic door closer consistent with the present disclosure in use.

FIG. 4B shows another perspective view of the automatic door closer of FIG. 4B.

FIG. 5 shows a perspective view of an arm of an automatic door closer consistent with some embodiments of the present disclosure.

While specific embodiments are illustrated in the figures, with the understanding that the disclosure is intended to be illustrative, these embodiments are not intended to limit the present disclosure described and illustrated herein.

### DETAILED DESCRIPTION

Generally, the present disclosure provides reliable automatic door closers suitable for use in a variety of high-frequency use settings, such as commercial walk-in cooler and/or freezer doors.

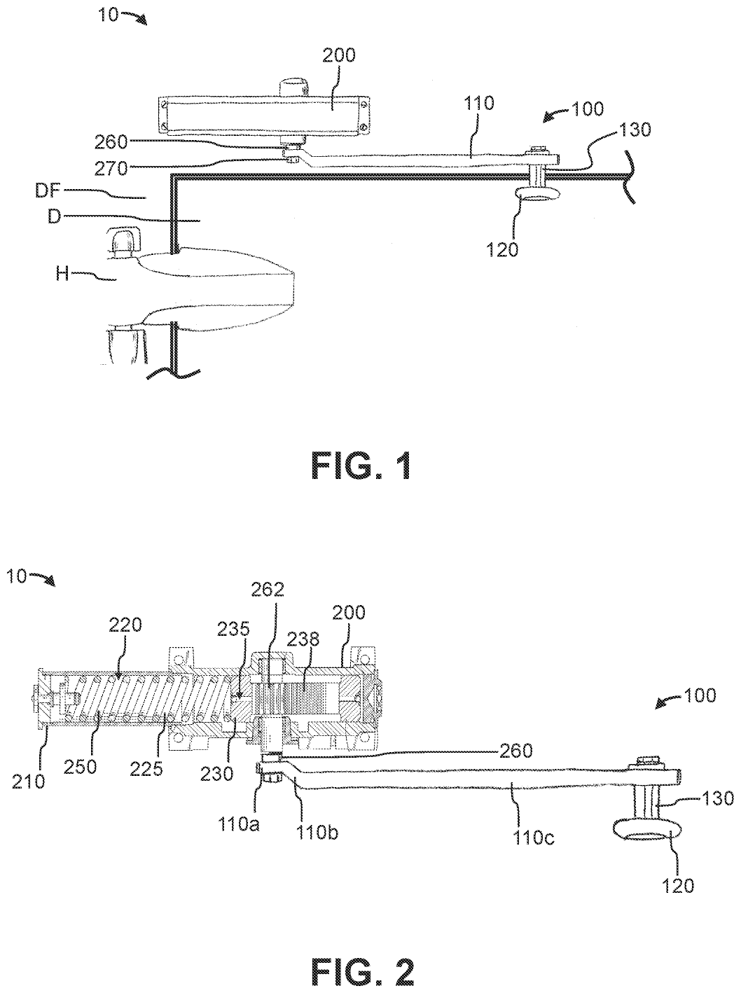

Referring generally to FIGS. 1-5, devices of the present disclosure comprise an unhinged inflexible arm component 100 rotatably connected to a base unit 200 and in contact with a door D.

The base unit 200 may be any suitable base unit including a rotatable spindle 260, such as a commercial-grade automatic door closer. Typically, automatic door closer base units 200 include an energy storage/release medium, such as a spring 250. Although the exact mechanism for how the automatic door closer base unit 200 accomplishes this energy storage and release may vary depending on the manufacturer, in general the spindle 260 rotates in a first, opening direction O when an opening force is applied to the door D, and the spindle rotates in a second, generally opposite closing direction C when the opening force is removed from the door D. In the example base unit 200 shown in FIG. 2, the base unit 200 includes an energy storage medium (e.g., spring 250) that compresses by a compression length CL (e.g., spring 250′) when the door D is forced open, and releases energy by relaxing (e.g., spring 250) when the opening force is removed from the door D.

The spindle 260 rotates in response to rotation of the inflexible arm component 100. The inflexible arm component 100 generally includes an arm 110 and a roller 120. The arm 110 includes a first end section 110a and a second end section 110c disposed substantially opposite the first end section 110a. The first end section 110a is associated with the spindle 260, for example by inserting a portion of the spindle 260 into a recess or hole 160 in the first end section 110a. In some embodiments, the recess or hole 160 includes a non-circular shape to reduce or eliminate undesirable slippage of the arm 110 relative to the spindle 260. In some embodiments, the first end section 110a is disposed substantially orthogonal to the axis of rotation of the spindle 260 to minimize torsional stress on the first end section 110a. In some embodiments, the second end section 110c is disposed substantially orthogonal to the axis of rotation of the door D (e.g., the axis of rotation defined by door hinge H) to minimize torsional stress on the second end section 110c.

The second end section 110c may be offset from the first end section 110a by an offset distance d. In some embodiments, the offset distance d reduces or eliminates interference between the top edge of the door D and the bottom of the spindle 260 or its associated retaining nut 270. In some embodiments, the offset distance d is determined by a middle section 110b disposed between the first end section 110a and the second end section 110c. The middle section 110b may be disposed at a first angle α relative to the first end section 110a, and at a second angle β relative to the second end section 110c. In some embodiments, the first angle α is about 85° to about 170°, for example about 85°, about 86°, about 87°, about 88°, about 89°, about 90°, about 91°, about 92°, about 93°, about 94°, about 95°, about 96°, about 97°, about 98°, about 99°, about 100°, about 101°, about 102°, about 103°, about 104°, about 105°, about 106°, about 107°, about 108°, about 109°, about 110°, about 111°, about 112°, about 113°, about 114°, about 115°, about 116°, about 117°, about 118°, about 119°, about 120°, about 121°, about 122°, about 123°, about 124°, about 125°, about 126°, about 127°, about 128°, about 129°, about 130°, about 131°, about 132°, about 133°, about 134°, about 135°, about 136°, about 137°, about 138°, about 139°, about 140°, about 141°, about 142°, about 143°, about 144°, about 145°, about 146°, about 147°, about 148°, about 149°, about 150°, about 151°, about 152°, about 153°, about 154°, about 155°, about 156°, about 157°, about 158°, about 159°, about 160°, about 161°, about 162°, about 163°, about 164°, about 165°, about 166°, about 167°, about 168°, about 169°, or about 170°. In some embodiments, the second angle β is about 85° to about 170°, for example about 85°, about 86°, about 87°, about 88°, about 89°, about 90°, about 91°, about 92°, about 93°, about 94°, about 95°, about 96°, about 97°, about 98°, about 99°, about 100°, about 101°, about 102°, about 103°, about 104°, about 105°, about 106°, about 107°, about 108°, about 109°, about 110°, about 111°, about 112°, about 113°, about 114°, about 115°, about 116°, about 117°, about 118°, about 119°, about 120°, about 121°, about 122°, about 123°, about 124°, about 125°, about 126°, about 127°, about 128°, about 129°, about 130°, about 131°, about 132°, about 133°, about 134°, about 135°, about 136°, about 137°, about 138°, about 139°, about 140°, about 141°, about 142°, about 143°, about 144°, about 145°, about 146°, about 147°, about 148°, about 149°, about 150°, about 151°, about 152°, about 153°, about 154°, about 155°, about 156°, about 157°, about 158°, about 159°, about 160°, about 161°, about 162°, about 163°, about 164°, about 165°, about 166°, about 167°, about 168°, about 169°, or about 170°. In some embodiments, the first angle α is about 135° and the second angle β is about 135°. In some embodiments, the first angle α and the second angle β are substantially similar, such that the first end section 110a and the second end section 110c are substantially parallel. In other embodiments, the middle section comprises or consists essentially of a curved section that gradually emerges from the relatively flat profile of the first end section 110a, and gradually emerges from the relatively flat profile of the second end section 110c. In some embodiments, the offset distance d is about 0.2 inches to about 3 inches, for example about 0.2 inches, about 0.3 inches, about 0.4 inches, about 0.5 inches, about 0.6 inches, about 0.7 inches, about 0.8 inches, about 0.9 inches, about 1 inches, about 1.1 inches, about 1.2 inches, about 1.3 inches, about 1.4 inches, about 1.5 inches, about 1.6 inches, about 1.7 inches, about 1.8 inches, about 1.9 inches, about 2 inches, about 2.1 inches, about 2.2 inches, about 2.3 inches, about 2.4 inches, about 2.5 inches, about 2.6 inches, about 2.7 inches, about 2.8 inches, about 2.9 inches, or about 3 inches.

The arm 110 may comprise any suitable material capable of withstanding significant opposing lateral forces from an opening door D and rotatable spindle 260. In some embodiments, the arm 110 comprises, consists essentially of, or consists of aluminum, iron, titanium, or a metal alloy such as steel (e.g., stainless steel). The exact thickness t of the material forming the arm 110 may vary depending on its composition. In general, however, the thickness t should allow convenient connection to an automatic door opener 200 (e.g., to the spindle 260). In some embodiments, the material forming the arm 110 has a thickness t of about 0.1 inches to about 1.5 inches, for example about 0.1 inches, about 0.2 inches, about 0.3 inches, about 0.4 inches, about 0.5 inches, about 0.6 inches, about 0.7 inches, about 0.8 inches, about 0.9 inches, about 1 inches, about 1.1 inches, about 1.2 inches, about 1.3 inches, about 1.4 inches, or about 1.5 inches. In some embodiments, the thickness t varies along the length of the arm 110, for example to provide additional strength at portions of the arm 110 while reducing the overall weight of the arm 110.

The width w of the material forming the arm 110 may vary depending on its composition. In general, however, the width w should allow convenient connection to an automatic door opener 200 (e.g., to the spindle 260). In some embodiments, the material forming the arm 110 has a width w of about 0.5 inches to about 2.5 inches, for example about 0.5 inches, about 0.6 inches, about 0.7 inches, about 0.8 inches, about 0.9 inches, about 1 inches, about 1.1 inches, about 1.2 inches, about 1.3 inches, about 1.4 inches, about 1.5 inches, about 1.6 inches, about 1.7 inches, about 1.8 inches, about 1.9 inches, about 2 inches, about 2.1 inches, about 2.2 inches, about 2.3 inches, about 2.4 inches, or about 2.5 inches. In some embodiments, the width w varies along the length of the arm 110, for example to provide additional strength at portions of the arm 110 while reducing the overall weight of the arm 110. In some embodiments, the width w tapers along the length of the arm 110, for example from a large width w of about 0.75 inches to about 1.5 inches at the first end section 110a, to a small width w of about 0.5 inches to about 1 inch at the second end section 110b. In other embodiments, the width w tapers along the length of the arm 110, for example from a small width w of about 0.5 inches to about 1 inch at the first end section 110a, to a large width w of about 0.75 inches to about 1.5 inches at the second end section 110b.

In some embodiments, the material forming the arm 110 has a thickness t of about 0.25 inches, and a width w of about 0.75 inches to about 1 inch.

The inflexible arm component 100 includes a roller 120 disposed proximate to the second end section 110c and substantially opposite the recess or hole 160. The roller 120 is rotatable relative to the inflexible arm component 100, and in operation contacts the door D. In some embodiments, the roller 120 comprises a non-marring surface, such as a rubber surface, to reduce or eliminate damage to the door D during operation. In some embodiments, an axle 130 is disposed between the roller 120 and the second end section 110c. The roller 120 may be rotatably associated with the axle 130 and/or with the second end section 110c by one or more retaining nuts 150.

In some embodiments, the roller 120 is offset from the second end section 110c by an offset distance d′. The offset distance d′ may, in some embodiments, ensure continuous contact between the roller 120 and the door D, reducing the possibility of the roller 120 slipping over the top edge of the door D or encountering resistance from an uneven (e.g., damaged) top edge of the door D. In some embodiments, the offset distance d′ may be about 0.2 inches to about 4 inches, for example about 0.2 inches, about 0.3 inches, about 0.4 inches, about 0.5 inches, about 0.6 inches, about 0.7 inches, about 0.8 inches, about 0.9 inches, about 1 inches, about 1.1 inches, about 1.2 inches, about 1.3 inches, about 1.4 inches, about 1.5 inches, about 1.6 inches, about 1.7 inches, about 1.8 inches, about 1.9 inches, about 2 inches, about 2.1 inches, about 2.2 inches, about 2.3 inches, about 2.4 inches, about 2.5 inches, about 2.6 inches, about 2.7 inches, about 2.8 inches, about 2.9 inches, about 3 inches, about 3.1 inches, about 3.2 inches, about 3.3 inches, about 3.4 inches, about 3.5 inches, about 3.6 inches, about 3.7 inches, about 3.8 inches, about 3.9 inches, or about 4 inches.

In some embodiments, a ratio of the width w to the thickness t of the arm 110 is about 1:1 to about 20:1, for example about 1:1, about 2:1, about 3:1, about 4:1, about 5:1, about 6:1, about 7:1, about 8:1, about 9:1, about 10:1, about 11:1, about 12:1, about 13:1, about 14:1, about 15:1, about 16:1, about 17:1, about 18:1, about 19:1, or about 20:1.

In some embodiments, the ratio of the second drop distance d′ to the first drop distance d is about 1:10 to about 10:1, for example about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, or about 10:1.

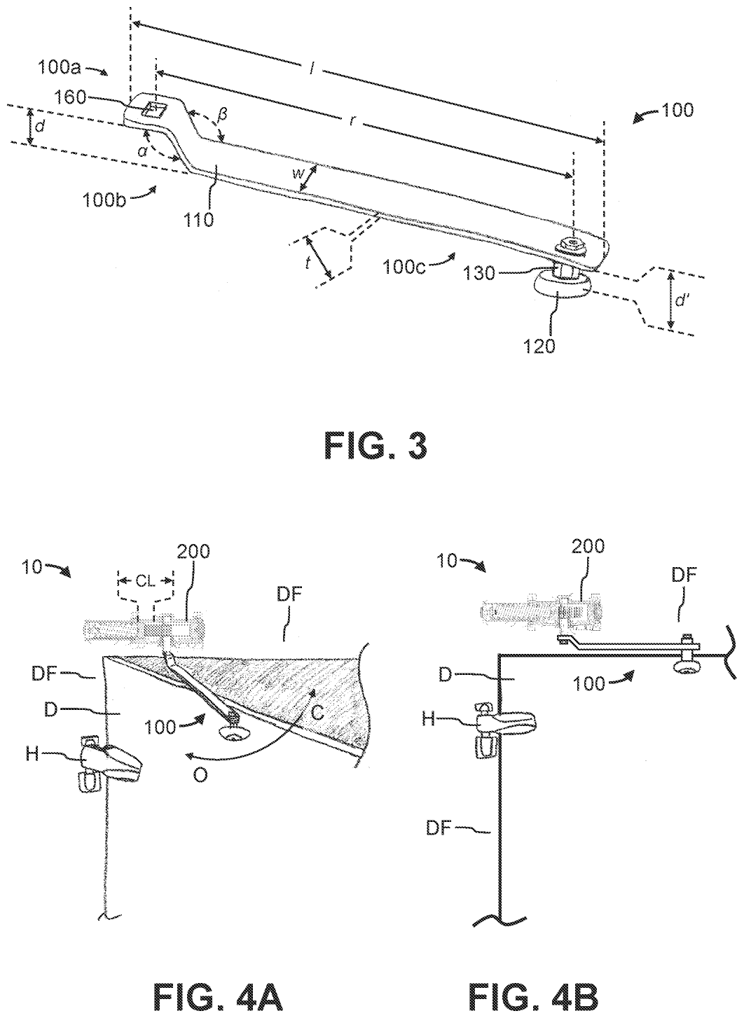

Referring now to FIG. 3, the arm 110 includes an operable radius r, defined by the distance between the recess or hole 160 and the roller 120. In general, a longer operable radius r is required for a heavier door D and/or a door D having a large width. In some embodiments, the operable radius r is about 10 inches to about 50 inches, for example about 10 inches, about 11 inches, about 12 inches, about 13 inches, about 14 inches, about 15 inches, about 16 inches, about 17 inches, about 18 inches, about 19 inches, about 20 inches, about 21 inches, about 22 inches, about 23 inches, about 24 inches, about 25 inches, about 26 inches, about 27 inches, about 28 inches, about 29 inches, about 30 inches, about 31 inches, about 32 inches, about 33 inches, about 34 inches, about 35 inches, about 36 inches, about 37 inches, about 38 inches, about 39 inches, about 40 inches, about 41 inches, about 42 inches, about 43 inches, about 44 inches, about 45 inches, about 46 inches, about 47 inches, about 48 inches, about 49 inches, or about 50 inches.

The arm 110 further includes a length l, defined by the maximum distance between the first end section 110a and the second end section 110c. The length l must be at least slightly longer than the operable radius r. In some embodiments, the length l is about 10 inches to about 50 inches, for example about 10 inches, about 11 inches, about 12 inches, about 13 inches, about 14 inches, about 15 inches, about 16 inches, about 17 inches, about 18 inches, about 19 inches, about 20 inches, about 21 inches, about 22 inches, about 23 inches, about 24 inches, about 25 inches, about 26 inches, about 27 inches, about 28 inches, about 29 inches, about 30 inches, about 31 inches, about 32 inches, about 33 inches, about 34 inches, about 35 inches, about 36 inches, about 37 inches, about 38 inches, about 39 inches, about 40 inches, about 41 inches, about 42 inches, about 43 inches, about 44 inches, about 45 inches, about 46 inches, about 47 inches, about 48 inches, about 49 inches, or about 50 inches.

In some embodiments, the second end section 110c represents at least about 50% of the length l, for example about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99% of the length l.

In some embodiments, the ratio of the length l to the radius r is about 2:1 to about 1.01:1, for example about 2:1, about 1.99:1, about 1.98:1, about 1.97:1, about 1.96:1, about 1.95:1, about 1.94:1, about 1.93:1, about 1.92:1, about 1.91:1, about 1.9:1, about 1.89:1, about 1.88:1, about 1.87:1, about 1.86:1, about 1.85:1, about 1.84:1, about 1.83:1, about 1.82:1, about 1.81:1, about 1.8:1, about 1.79:1, about 1.78:1, about 1.77:1, about 1.76:1, about 1.75:1, about 1.74:1, about 1.73:1, about 1.72:1, about 1.71:1, about 1.7:1, about 1.69:1, about 1.68:1, about 1.67:1, about 1.66:1, about 1.65:1, about 1.64:1, about 1.63:1, about 1.62:1, about 1.61:1, about 1.6:1, about 1.59:1, about 1.58:1, about 1.57:1, about 1.56:1, about 1.55:1, about 1.54:1, about 1.53:1, about 1.52:1, about 1.51:1, about 1.5:1, about 1.49:1, about 1.48:1, about 1.47:1, about 1.46:1, about 1.45:1, about 1.44:1, about 1.43:1, about 1.42:1, about 1.41:1, about 1.4:1, about 1.39:1, about 1.38:1, about 1.37:1, about 1.36:1, about 1.35:1, about 1.34:1, about 1.33:1, about 1.32:1, about 1.31:1, about 1.3:1, about 1.29:1, about 1.28:1, about 1.27:1, about 1.26:1, about 1.25:1, about 1.24:1, about 1.23:1, about 1.22:1, about 1.21:1, about 1.2:1, about 1.19:1, about 1.18:1, about 1.17:1, about 1.16:1, about 1.15:1, about 1.14:1, about 1.13:1, about 1.12:1, about 1.11:1, about 1.1:1, about 1.09:1, about 1.08:1, about 1.07:1, about 1.06:1, about 1.05:1, about 1.04:1, about 1.03:1, about 1.02:1, about 1.01:1, or about 1:1.

In some embodiments, the arm 110 includes a ratio of the radius r to a compression length CL of the energy storage medium (e.g., spring 250) of about 1 to about 20, for example about 1, about 2, about 3, about 4, about 5, about 6, about 7, about 8, about 9, about 10, about 11, about 12, about 13, about 14, about 15, about 16, about 17, about 18, about 19, or about 20.

In some embodiments, the arm 110 does not include a hinge. In such embodiments, the arm 110 includes a single length of material that is substantially rigid and does not substantially flex laterally in response to lateral stress imparted by the door D or by the spindle 260.

In some embodiments, the present disclosure provides a door closer (10) comprising: an energy storage component (200) including a rotatable spindle (260); and an inflexible arm component (100) in mechanical association with the rotatable spindle 260 and comprising: an arm (110) having a first end section (110a) associated with the rotatable spindle 260, a second end section (110c) disposed substantially opposite the first end section 110a, a middle section (110b) disposed between the first end section 110a and the section end section 110c, and a roller (120) at the second end section 110c substantially opposite the first end section 110a. In some embodiments, the middle section (110b) defines a first drop distance d between an elevation at the first end section (110a) and an elevation at the second end section (110c). In some embodiments, the roller 120 is in rotational communication with the inflexible arm component 100. In some embodiments, the roller 120 is disposed below the arm 110 by a second drop distance d′. In some embodiments, in operation, the energy storage component 200 stores energy upon rotation of the inflexible arm component 100 in a first direction O, and the inflexible arm component 100 is forced in a second direction C substantially opposite the first direction O when the energy storage component 200 releases the stored energy. In some embodiments, the arm 110 has an operational radius r of about 7 inches to about 9.5 inches. In some embodiments, the arm 110 has a ratio of an operational radius r to a linear maximum compression length of spring force CL of about 3 to about 8. In some embodiments, the second end section 110c comprises at least about 80% of the length l of the inflexible arm component 100.

In some embodiments, the present disclosure provides an inflexible arm component 100 for use with an automatic door closer base unit 200, the inflexible arm component 100 comprising: a first end section (110a) configured to mate with a rotatable spindle (260) of the automatic door closer base unit 200; a second end section (110c) disposed substantially opposite the first end section 110a and associated with a roller (120); and a middle section (110b) disposed between the first end section 110a and the section end section 110c. In some embodiments, the second end section 110c is offset from the first end section 110a by a first drop distance d. In some embodiments, the roller 120 is offset from the second end section 110c by a second drop distance d′. In some embodiments, the first drop distance d is about 0.25 inches to about 2 inches. In some embodiments, the second drop distance d′ is about 0.5 inches to about 3 inches. In some embodiments, the inflexible arm component 100 has a ratio of the second drop distance d′ to the first drop distance d of about 1:1 to about 5:1. In some embodiments, the inflexible arm component 100 has an operational radius r of about 7 inches to about 9.5 inches.

In some embodiments, the present disclosure provides an automatic door closer 10 comprising: a housing (210) including: a longitudinal bore (220); a spring (250) disposed in the longitudinal bore; a piston (230) disposed in the longitudinal bore 220 and adjacent the spring 250, the piston 230 including: an orifice (235) in restricted fluid communication with the longitudinal bore 220, and a toothed rack (238) disposed within the orifice 235; hydraulic fluid (225) the longitudinal bore 220; a toothed pinion (262) in rotational communication with the toothed rack 238 and including a post (260) external to the housing 210; and an arm (100) in non-rotational mechanical communication with the post 260, the arm 100 consisting essentially of: a non-hinged shaft (110) extending longitudinally from the post 260 and including a proximate end (110a) in mechanical communication with the post 260 and a distal end (110c) opposite the proximate end 110a, and a roller (120) disposed at the proximate end 110a of the non-hinged shaft 110 and in rotational communication with the non-hinged shaft 110.

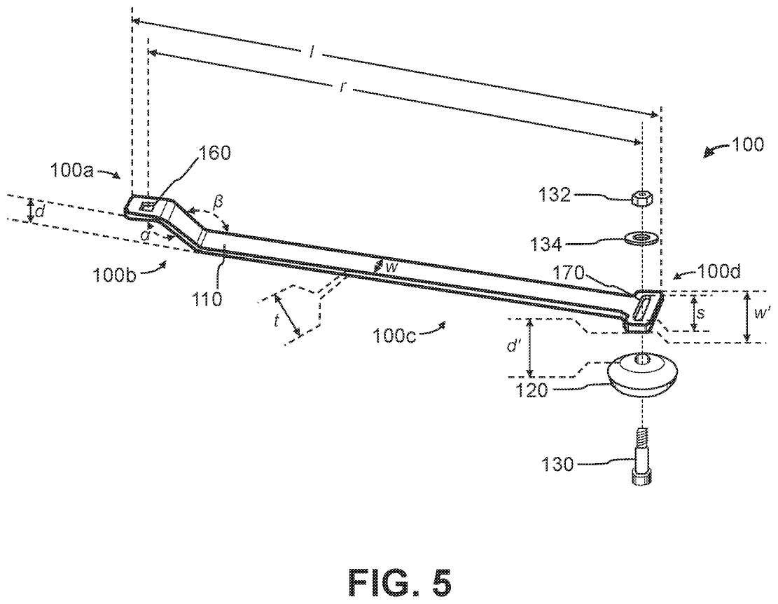

Referring now to FIG. 5, the unhinged inflexible arm component 100 in some embodiments includes a wide end section 100d disposed generally opposite the first end section 100a, and includes an elongated slot 170 for adjustably engaging with the roller 120 (e.g., via a shoulder screw/bolt 130 disposed through the roller 120 and the elongated slot 170 and secured with a washer 134 and a nut 132). The elongated slot 170 has a length s that is longer (e.g., substantially longer) than the outside diameter of the portion of the bolt/screw 130 that extends therethrough. The elongated length s is disposed generally tangential to the radius r of the unhinged inflexible arm component 100, and allows for fine adjustment of the position of the roller 120 relative to the door D, for example if the surface of the door D is recessed (or protrudes) relative to the surface of the door frame DF. In some embodiments, the length s of the elongated slot 170 is about 0.7 inches to about 2 inches, for example about 0.7 inches, about 0.8 inches, about 0.9 inches, about 1.0 inches, about 1.1 inches, about 1.2 inches, about 1.3 inches, about 1.4 inches, about 1.5 inches, about 1.6 inches, about 1.7 inches, about 1.8 inches, about 1.9 inches, or about 2.0 inches. To accommodate the length s of the elongated slot 170, the wide end section 100d may have a width w′ that is wider than the length s of the elongated slot 170 and sufficiently wider than the length s to reduce or eliminate destructive failure of the wide end portion 100d from stress imparted on the wide end portion 100d by the bolt/screw 130 (e.g., from repeated impacts between the roller 120 and the door D). In some embodiments, the width w′ is about 0.2 inches to about 1 inch wider than the length s, for example about 0.2 inches, about 0.3 inches, about 0.4 inches, about 0.5 inches, about 0.6 inches, about 0.7 inches, about 0.8 inches, about 0.9 inches, or about 1.0 inch wider than the length s.

The arm 110 includes an operable radius r, defined by the distance between the recess or hole 160 and the roller 120. In general, a longer operable radius r is required for a heavier door D and/or a door D having a large width. In some embodiments, the operable radius r is about 10 inches to about 50 inches, for example about 10 inches, about 11 inches, about 12 inches, about 13 inches, about 14 inches, about 15 inches, about 16 inches, about 17 inches, about 18 inches, about 19 inches, about 20 inches, about 21 inches, about 22 inches, about 23 inches, about 24 inches, about 25 inches, about 26 inches, about 27 inches, about 28 inches, about 29 inches, about 30 inches, about 31 inches, about 32 inches, about 33 inches, about 34 inches, about 35 inches, about 36 inches, about 37 inches, about 38 inches, about 39 inches, about 40 inches, about 41 inches, about 42 inches, about 43 inches, about 44 inches, about 45 inches, about 46 inches, about 47 inches, about 48 inches, about 49 inches, or about 50 inches.

The arm 110 further includes a length l, defined by the maximum distance between the first end section 110a and the second end section 110c. The length l must be at least slightly longer than the operable radius r. In some embodiments, the length l is about 10 inches to about 50 inches, for example about 10 inches, about 11 inches, about 12 inches, about 13 inches, about 14 inches, about 15 inches, about 16 inches, about 17 inches, about 18 inches, about 19 inches, about 20 inches, about 21 inches, about 22 inches, about 23 inches, about 24 inches, about 25 inches, about 26 inches, about 27 inches, about 28 inches, about 29 inches, about 30 inches, about 31 inches, about 32 inches, about 33 inches, about 34 inches, about 35 inches, about 36 inches, about 37 inches, about 38 inches, about 39 inches, about 40 inches, about 41 inches, about 42 inches, about 43 inches, about 44 inches, about 45 inches, about 46 inches, about 47 inches, about 48 inches, about 49 inches, or about 50 inches.

In some embodiments, the second end section 110c represents at least about 50% of the length l, for example about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99% of the length l.

In some embodiments, the ratio of the length l to the radius r is about 2:1 to about 1.01:1, for example about 2:1, about 1.99:1, about 1.98:1, about 1.97:1, about 1.96:1, about 1.95:1, about 1.94:1, about 1.93:1, about 1.92:1, about 1.91:1, about 1.9:1, about 1.89:1, about 1.88:1, about 1.87:1, about 1.86:1, about 1.85:1, about 1.84:1, about 1.83:1, about 1.82:1, about 1.81:1, about 1.8:1, about 1.79:1, about 1.78:1, about 1.77:1, about 1.76:1, about 1.75:1, about 1.74:1, about 1.73:1, about 1.72:1, about 1.71:1, about 1.7:1, about 1.69:1, about 1.68:1, about 1.67:1, about 1.66:1, about 1.65:1, about 1.64:1, about 1.63:1, about 1.62:1, about 1.61:1, about 1.6:1, about 1.59:1, about 1.58:1, about 1.57:1, about 1.56:1, about 1.55:1, about 1.54:1, about 1.53:1, about 1.52:1, about 1.51:1, about 1.5:1, about 1.49:1, about 1.48:1, about 1.47:1, about 1.46:1, about 1.45:1, about 1.44:1, about 1.43:1, about 1.42:1, about 1.41:1, about 1.4:1, about 1.39:1, about 1.38:1, about 1.37:1, about 1.36:1, about 1.35:1, about 1.34:1, about 1.33:1, about 1.32:1, about 1.31:1, about 1.3:1, about 1.29:1, about 1.28:1, about 1.27:1, about 1.26:1, about 1.25:1, about 1.24:1, about 1.23:1, about 1.22:1, about 1.21:1, about 1.2:1, about 1.19:1, about 1.18:1, about 1.17:1, about 1.16:1, about 1.15:1, about 1.14:1, about 1.13:1, about 1.12:1, about 1.11:1, about 1.1:1, about 1.09:1, about 1.08:1, about 1.07:1, about 1.06:1, about 1.05:1, about 1.04:1, about 1.03:1, about 1.02:1, about 1.01:1, or about 1:1.

In some embodiments, the arm 110 includes a ratio of the radius r to a compression length CL of the energy storage medium (e.g., spring 250) of about 1 to about 20, for example about 1, about 2, about 3, about 4, about 5, about 6, about 7, about 8, about 9, about 10, about 11, about 12, about 13, about 14, about 15, about 16, about 17, about 18, about 19, or about 20.

In some embodiments, the arm 110 does not include a hinge. In such embodiments, the arm 110 includes a single length of material that is substantially rigid and does not substantially flex laterally in response to lateral stress imparted by the door D or by the spindle 260.

In some embodiments, the present disclosure provides a door closer (10) comprising: an energy storage component (200) including a rotatable spindle (260); and an inflexible arm component (100) in mechanical association with the rotatable spindle 260 and comprising: an arm (110) having a first end section (110a) associated with the rotatable spindle 260, a second end section (110c) disposed substantially opposite the first end section 110a, a middle section (110b) disposed between the first end section 110a and the section end section 110c, and a roller (120) at the second end section 110c substantially opposite the first end section 110a. In some embodiments, the middle section (110b) defines a first drop distance d between an elevation at the first end section (110a) and an elevation at the second end section (110c). In some embodiments, the roller 120 is in rotational communication with the inflexible arm component 100. In some embodiments, the roller 120 is disposed below the arm 110 by a second drop distance d′. In some embodiments, in operation, the energy storage component 200 stores energy upon rotation of the inflexible arm component 100 in a first direction O, and the inflexible arm component 100 is forced in a second direction C substantially opposite the first direction O when the energy storage component 200 releases the stored energy. In some embodiments, the arm 110 has an operational radius r of about 7 inches to about 9.5 inches. In some embodiments, the arm 110 has a ratio of an operational radius r to a linear maximum compression length of spring force CL of about 3 to about 8. In some embodiments, the second end section 110c comprises at least about 80% of the length l of the inflexible arm component 100.

In some embodiments, the present disclosure provides an inflexible arm component 100 for use with an automatic door closer base unit 200, the inflexible arm component 100 comprising: a first end section (110a) configured to mate with a rotatable spindle (260) of the automatic door closer base unit 200; a second end section (110c) disposed substantially opposite the first end section 110a and associated with a roller (120); and a middle section (110b) disposed between the first end section 110a and the section end section 110c. In some embodiments, the second end section 110c is offset from the first end section 110a by a first drop distance d. In some embodiments, the roller 120 is offset from the second end section 110c by a second drop distance d′. In some embodiments, the first drop distance d is about 0.25 inches to about 2 inches. In some embodiments, the second drop distance d′ is about 0.5 inches to about 3 inches. In some embodiments, the inflexible arm component 100 has a ratio of the second drop distance d′ to the first drop distance d of about 1:1 to about 5:1. In some embodiments, the inflexible arm component 100 has an operational radius r of about 7 inches to about 9.5 inches.

In some embodiments, the present disclosure provides an automatic door closer 10 comprising: a housing (210) including: a longitudinal bore (220); a spring (250) disposed in the longitudinal bore; a piston (230) disposed in the longitudinal bore 220 and adjacent the spring 250, the piston 230 including: an orifice (235) in restricted fluid communication with the longitudinal bore 220, and a toothed rack (238) disposed within the orifice 235; hydraulic fluid (225) the longitudinal bore 220; a toothed pinion (262) in rotational communication with the toothed rack 238 and including a post (260) external to the housing 210; and an arm (100) in non-rotational mechanical communication with the post 260, the arm 100 consisting essentially of: a non-hinged shaft (110) extending longitudinally from the post 260 and including a proximate end (110a) in mechanical communication with the post 260 and a distal end (110c) opposite the proximate end 110a, and a roller (120) disposed at the proximate end 110a of the non-hinged shaft 110 and in rotational communication with the non-hinged shaft 110.

### Example

An automatic door closer 10 having an energy storage unit 200 consistent with the energy storage units 200 disclosed herein (Dorence DI 100S, Mantra Enterprise, Phoenix, AZ) was equipped with an inflexible arm component 100 consistent with the embodiment specifically shown in FIG. 5 and having the following approximate dimensions:

| Parameter | Dimension | |
|---|---|---|
| Thickness, t | 0.14 | inches |
| Length, l | 13.2 | inches |
| Radius, r | 12.4 | inches |
| Offset, d | 0.63 | inches |
| Width, w | 0.88 | inches |
| Offset angle, α | ~135° | |
| Offset angle, β | ~135° | |
| End width, w′ | 1.75 | inches |
| Slot length, s | ~1.5 | inches |

After securing the energy storage unit 200 to a door frame DF generally near the same side as the hinges H with the inflexible arm component 100 extending away from the hinges H, the roller 120 was slid along the elongated slot 170 of the wide end portion 100d until the roller 120 was in contact with the outer surface of a standard industrial walk-in freezer door D. The shoulder screw 130 and associated bolt 132 were then tightened relative to each other to secure the roller 120 to the wide end portion 100d.

To test the operation and reliability of the automatic door closer 10, the door D was opened in the direction of the automatic door closer 10 and released. Energy stored in the energy storage unit 200 forced the inflexible arm component 100 back towards the surface of the door D until the roller 120 made contact with the surface of the door D. Additional release of energy from the energy storage unit 200 continued to rotate the inflexible arm component 100 until the door D securely closed against the door frame DF. This automatic door closer 10 closed the freezer door D more reliably than current commercially-available freezer door hinge-and-and latch systems (e.g., by Kason Industries), and without any perceptible damage to the door D, the door handle, the door hinges H, or the door frame DF.

What is claimed is:

1. A door closer comprising:
an energy storage component including a rotatable spindle; and
an inflexible arm component in mechanical association with the rotatable spindle and comprising:
an arm having a first end section associated with the rotatable spindle,
a second end section disposed substantially opposite the first end section,
a middle section disposed between the first end section and the section end section, and
a roller at the second end section substantially opposite the first end section.

2. The door closer of claim 1, wherein the middle section defines a first drop distance between an elevation at the first end section and an elevation at the second end section.

3. The door closer of claim 1, wherein the roller is in rotational communication with the inflexible arm component.

4. The door closer of claim 1, wherein the roller is disposed below the arm by a second drop distance.

5. The door closer of claim 1, in operation, the energy storage component stores energy upon rotation of the inflexible arm component in a first direction, and wherein the inflexible arm component is forced in a second direction substantially opposite the first direction when the energy storage component releases the stored energy.

6. The door closer of claim 1, wherein the arm has an operational radius of about 7 inches to about 9.5 inches.

7. The door closer of claim 1, wherein the arm has a ratio of an operational radius to a linear maximum compression length of spring force of about 3 to about 8.

8. The door closer of claim 1, wherein the second end section comprises at least about 80% of a length of the inflexible arm component.

9. The door closer of claim 1 further comprising a wide end section disposed opposite the first end section and having a width that is larger than the width of the second end section.

10. The door closer of claim 9, wherein the wide end section includes an elongated slot disposed generally tangential to an operational radius of the inflexible arm component and configured to rotatably mate with the roller.

11. An inflexible arm component for use with an automatic door closer base unit, the arm component comprising:
a first end section configured to mate with a rotatable spindle of the automatic door closer base unit;
a second end section disposed substantially opposite the first end section and associated with a roller; and
a middle section disposed between the first end section and the section end section.

12. The inflexible arm component of claim 11, wherein the second end section is offset from the first end section by a first drop distance.

13. The inflexible arm component of claim 11, wherein the roller is offset from the second end section by a second drop distance.

14. The inflexible arm component of claim 12, wherein the first drop distance is about 0.25 inches to about 2 inches.

15. The inflexible arm component of claim 13, wherein the second drop distance is about 0.5 inches to about 3 inches.

16. The inflexible arm component of claim 13, wherein the inflexible arm component has a ratio of the second drop distance to the first drop distance of about 1:1 to about 5:1.

17. The inflexible arm component of claim 11, wherein the inflexible arm component has an operational radius of about 7 inches to about 9.5 inches.

18. The inflexible arm component of claim 11 further comprising a wide end section disposed opposite the first end section and having a width that is larger than the width of the second end section.

19. The inflexible arm component of claim 18, wherein the wide end section includes an elongated slot disposed generally tangential to an operational radius of the inflexible arm component and configured to rotatably mate with the roller.

20. An automatic door closer comprising:
a housing including:
a longitudinal bore;
a spring disposed in the longitudinal bore;
a piston disposed in the longitudinal bore and adjacent the spring, the piston including:
an orifice in restricted fluid communication with the longitudinal bore, and
a toothed rack disposed within the orifice;
hydraulic fluid the longitudinal bore;
a toothed pinion in rotational communication with the toothed rack and including a post external to the housing; and
an arm in non-rotational mechanical communication with the post, the arm consisting essentially of:
a non-hinged shaft extending longitudinally from the post and including a proximate end in mechanical communication with the post and a distal end opposite the proximate end, and
a roller disposed at the proximate end of the non-hinged shaft and in rotational communication with the non-hinged shaft.
